(19) United States
(12) Patent Application Publication
(10) Pub. No.: US 2007/0027931 A1
(43) Pub. Date: Feb. 1, 2007

(54) System and method for organizing repositories of information and publishing in a personalized manner

(76) Inventor: Indra Heckenbach, Santa Cruz, CA (US)

Correspondence Address: WEST & ASSOCIATES, A PC, 2815 MITCHELL DRIVE, SUITE 209, WALNUT CREEK, CA, 94598, US

(21) Appl. No.: 11/409,316

(22) Filed: Apr. 21, 2006

Related U.S. Application Data
(60) Provisional application No. 60/703,575, filed on Jul. 29, 2005.

(51) Int. Cl. G06F 17/30

(52) U.S. Cl. 707/200

(57) ABSTRACT

An information system, used for collecting and organizing content using rich metadata and/or other classes of information, analyzing the content using various algorithms, and publishing the content to users in various formats. The system can have aspects of a database, analysis system, document publishing system, and user interactivity interface.

### PRIORITY

This application is related to and claims priority under 35 U.S.C. 119(e) to U.S. Provisional Patent Application No.: 60/703,575 filed on Jul. 29, 2005 entitled “System and method for organizing repositories of information and publishing in a personalized manner” by I. Heckenbach.

### BACKGROUND

1. Field of the Invention

The present invention is related to a system and method for organizing repositories of information.

2. Description of the Related Art

A complex knowledge system (1) can be formed through the contributions of many small pieces of knowledge by one or more contributors. With the application of relatively simple rules, complex patterns of knowledge can be formed and complex behaviors can take place. These complex patterns and/or behaviors can be useful, and, they can be said to “emerge” from the system. Thus, such a system can be described as emergent, and/or having emergence, and/or having emergent properties.

Some web-based software systems have been identified as emergent. For example, a technical news forum has frequent topical discussions, wherein numerous users submit comments, and wherein moderators vote comments up or down, using a simple rating scale. Following a news posting, viewers can read the news and look below to see the top rated comments. This approach can bring the best content (funny, interesting, useful, etc) to the top, forming a review of the news article from the submissions of many readers.

Another web-based system has developed an on-line encyclopedia, using the contributions of numerous authors. From numerous contributions of amateurs and professionals, working independently without a schedule or development plan, an extensive encyclopedia has emerged.

Of particular interest are systems in which the knowledge is arranged by certain simple rules, but the higher-level structure, process, and content emerge from the lower-level activity. The structure of documents produced by such systems emerges without benefit of a previously determined set of organizing rules. The process by which contributors provide pieces of knowledge to the system is not explicitly managed, nor assigned by an individual. That is, the process of writing is not managed as writing for publication, commercial or otherwise, is traditionally managed. The content selected for publication within documents produced by the system is not determined explicitly by one or more individuals; the selection of content results from the system's application of simple rules to information within the system.

In one example system, postings on a site can be automatically selected for publication responsive to moderators' votes regards content quality of the material under consideration. There can be a limited number of moderators, and moderators can each and/or all together have a limited number of votes. In another example system, an essentially unlimited number of contributors can each directly modify content that is published on a website. These are examples of systems in which simple rules are applied to information within the system, resulting in a non-traditional publishing process that can have emergent properties.

In the above example of a news forum system, ratings are provided along a single dimension for an element of information. What is needed is a multi-demensional rating system in which viewers or other users of a system can provide ratings along multiple scales for a particular element of content or group of elements of content.

In the above example of a news forum system, one-dimensional ratings are used to select the best elements of content for publication. This presumes a single instance of publication corresponding to a global consensus; that is, a single evaluation of “best”, at any one moment. What is needed is a system with the capability of personalized document generation, in which publications can differ for individual viewers and/or classes of viewers, the publications can differ from each other responsive to characteristics of the individual viewers and/or classes of viewers, and the publications can differ from each other responsive to multi-dimensional ratings and other information in the system.

Some web-based systems provide one or more of a travel guide, a compendium of one or more travel journals, and an activity-guide; these can be referred to as Travel sites. Travel sites can have emergent properties. Travel sites can benefit from the features of multi-dimensional ratings and personalized document generation, particularly when taking into account personal preferences.

Some web-based systems provide information and support regarding food recipes and/or diets; these can be referred to as Food sites. Food sites can have emergent properties. Food sites can benefit from the features of multi-dimensional ratings and personalized document generation.

Some web-based systems provide capabilities relating to social networking; these can be referred to as Social Networking sites. Social Networking sites can have emergent properties.

Travel sites and Food sites are examples of knowledge-based systems. Combining the capabilities of these knowledge-based systems with social networking capabilities can enhance the usefulness of the knowledge-based systems. Adding knowledge-based capabilities to Social Networking sites, similarly, can add value to those systems.

What is needed is a core system framework capable of supporting more than one knowledge-based application, and, a core system framework capable of supporting other applications such as Social Networking while supporting more than one knowledge-based application.

(1) Knowledge System-An organized structure and dynamic process (a) generating and representing content, components, classes, or types of knowledge, that is (b) domain specific or characterized by domain relevant defined by the user or consumer, (c) reinforced by a set of logical relationships that connect the content of knowledge to its value (utility), and (d) enhanced by a set of iterative processes that enable the evolution, revision, adaptation, and advances, and (e) subject to criteria of relevance, reliability, and quality. Professor Nazli Choucri [

http://ocw.mit.edu/NR/rdonlyres/Political-Science/17-181Spring2003/D6E6182F-9184-4B85-849D-C2D09BCE308A/0/week4.pdf]

### BRIEF DESCRIPTION OF THE DRAWINGS

FIG. 1 is a block diagram of a system in the context of authors and viewers.

FIG. 2A is a component diagram of a system

FIG. 2B is a component diagram illustrating detail of application components

FIG. 2C is a component diagram illustrating detail of a generic core

FIG. 3 is a use case diagram of a system

FIG. 4A is a class diagram illustrating data structures of a generic engine

FIG. 4B is a class diagram illustrating data structures of a generic engine

FIG. 4C is a class diagram illustrating data structures of a generic engine

FIG. 5A is a class diagram illustrating data structures of an analysis engine

FIG. 5B is a class diagram illustrating data structures of an analysis engine

FIG. 6 depicts a computer system on which the system and method of the preceding figures can be implemented.

### DETAILED DESCRIPTION

These embodiments can address a class of problems in which there exists a large set of knowledge whose content elements can be combined in various ways to form new products.

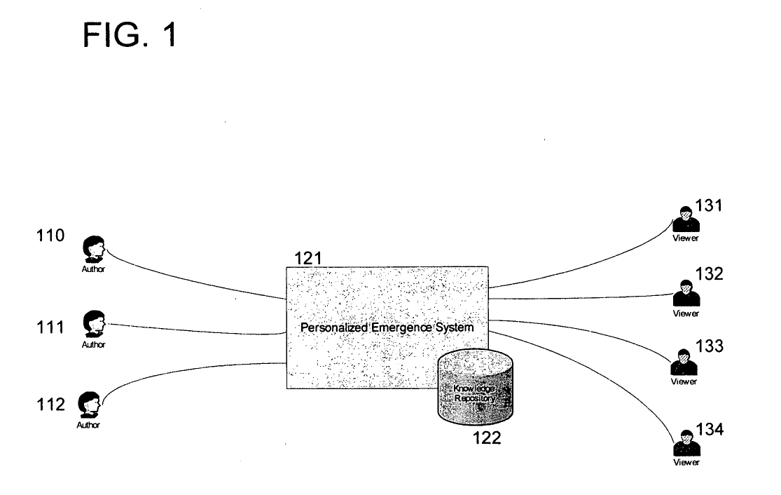

FIG. 1 illustrates a system 121 that functions to organize a repository of knowledge. Knowledge in the repository can be represented using data. Individual content elements can be convenient and/or useful groupings of knowledge representations in the system. The system can present content elements to match the interests of one or more viewers. In some embodiments, some presentations of content elements can be published documents. In some embodiments the Personalized Emergence System 121 can be implemented by means of software processes that function in the context of a computer system. The contents of a knowledge repository, that is, a repository of knowledge 122, can be comprised of content elements. The content elements can be stored and/or organized in a database system. Individual viewers 131-134 and/or classes of viewers can interact with the system. A viewer can be an individual person or an automated proxy. An automated proxy can represent a class of individuals such as a specific market demographic, yet still act as a single viewer. The system can contain representations of interests of particular individual viewers and/or classes of viewers. The system can take into account particular individual viewer (and/or class of viewer) interests in presenting content elements and/or in publishing documents for the corresponding viewer or class of viewers. Such presentations and/or publications can be described as personalized. In some embodiments, large numbers of viewers can be supported.

Terminology: Users of the system can include individuals and/or classes of individuals that can interact with the system. Users of the system can also include automated proxies for individuals and/or classes of individuals that interact with the system. Users of the system can also include other (similar or dis-similar) systems and/or any other known and/or convenient entity that interacts with the system. Some users can be classified according to their interactions with the system. Non-limiting examples of such user classifications can include viewers, contributors, authors, readers, moderators, voters, and administrators. Classifications of users are not necessarily mutually exclusive. By way of non-limiting example, some specific viewers can be also be contributors, but not all viewers are necessarily contributors.

A system embodiment can use a knowledge repository whose contents are fully or partially static. That is, the contents of the knowledge repository may be a fixed body of work. In some embodiments the knowledge repository contents can be dynamic; one or more contributors can contribute additional content, and/or changes to content, over time. In some embodiments, large numbers of content contributors, including authors, can be supported.

Characteristics of individual viewers and/or classes of viewers can be known to the system, such as viewers' interests. In addition to having the capability of capturing explicitly stated viewer characteristics, the system can derive viewer characteristics from other information present in the system.

Viewers' interests can encompass preferences stated by individual viewers and/or classes of viewers, and, preferences that are derived by the system. “Viewer preferences” of an individual viewer or individual class of viewers is a “viewer's preferences”. A plurality of viewers or classes of viewers, taken together, can have “viewers' preferences”. For the purposes of this document, the terms “viewer preferences”, “viewer's preferences”, and “viewers' preferences” all include both stated and derived preferences, unless otherwise explicitly qualified.

The system can also support ratings and properties associated with corresponding content elements and associated with other corresponding information. In some embodiments ratings and properties can be dynamic, and can be generated or modified by various users of the system. Similarly, metadata corresponding to content elements and metadata corresponding to other information in the system can be supported. Ratings and properties can be considered metadata. Other types of information can also be considered metadata.

In some embodiments metadata constructs can be instantiated dynamically. The term “flexible metadata” refers to this capability. In one example embodiment, a system administrator can define a property such as “population” for a “Location”. Thereafter, all instantiations of “Location” can be assigned a “population.”

In publishing personalized documents, the system can take into account viewers' characteristics, including preferences, and other information in the system. Other information in the system which can be taken into account can comprise content elements and/or metadata classes. Examples of metadata classes include metadata, property information, rating information, user information, group information, and any other known and/or convenient class of information. Content elements can comprise one or more of text, images, photographs, audio, video, and any other known and/or convenient form of information. Documents published by the system can include content elements and/or instances of metadata classes. It follows that published documents can comprise text, images, photographs, audio, video, and any other known and/or convenient form of information.

User information can include identification of particular users. For example, identification of a viewer as a particular user can be utilized by the system to responsively personalize documents for that particular user. User information can also include relationships. Some examples of relationships are friends, and, friends of friends. A user can have user information that designates other particular users as friends. User information for a particular user can also include demographic information associated with that user and/or other known and/or convenient classifications of information associated with that user.

In some embodiments each user can explicitly create a set of groups. Users can use groups in order to conveniently organize their relationships to friends. A level of trust for specific other users can be indicated by associating a level of trust with another user or a defined group. A level of trust that is associated with another user or a group can be used by or for a user as a weighting parameter for considering recommendations and/or other information associated with the other user or group.

In some embodiments the system can create one or more groups of users based upon similarities of those users according to one or more specific criteria. By way of non-limiting example, in some embodiments the system can create a group of users based on similar personal age and gender, such as “males older than 50 years”.

Group information can include identification of users within a group of users. Group information can also include relationships. Users and groups can have relationships. For example, a particular user may express a level of trust such as increased confidence in information contributed by members of a particular group; such information can be used by the system to personalize documents produced for the particular user.

In some embodiments level of trust can be partially or fully inherited. By way of non-limiting example, in the case where userA user information includes a level of trust regarding userB, and, userB user information includes a level of trust regarding userC, the system can provide a weighting parameter for userA to use in considering recommendations and/or other information associated with userC.

Some embodiments as described herein can support one or more high-level products such as travel sites and/or travel guides wherein the content for presentation and/or publishing can be selected, that is, personalized, responsive to viewers' interests. A viewer's interests relating to travel guides can include one or more of the following or any other known and/or convenient areas of interest: Activity Types, Destination Types, Content Types, Writing Types, and Author Types.

Activity Types can include restaurant types, entertainment types, hotel types, and outing types. By way of non-limiting example, restaurant types can include Indian restaurants and/or spicy food, and/or any known and/or convenient restaurant type designation. By way of non-limiting example entertainment types can include jazz clubs and/or any known and/or convenient entertainment type designation, By way of non-limiting example hotel types can include luxury hotels with room rates below a designated cost threshold and/or any known and/or convenient hotel type designation, By way of non-limiting example, outing types can include hiking spots and/or any known and/or convenient outing type designation.

By way of non-limiting example, Destination Types can include specific cities on a user's itinerary and/or any known and/or convenient destination type designation.

By way of non-limiting examples, Content Types can include historical, architectural, artistic, practical, and budget preferences and/or any known and/or convenient content type designation.

By way of non-limiting examples, Writing Types can include style preferences such as humorous, pragmatic, and/or witty.

By way of non-limiting examples, Author Type can include preferences for author's age range, author's gender, author's similarity to the user, and/or other personal properties of an author.

In some embodiments, a measure of similarity between users can be evaluated. Such evaluation can be based on one or more of several criteria. By way of non-limiting examples, these criteria can include “named friends”, “similar user profile”, “similar user history”, and/or any known and/or convenient similarity criteria. “Named friends” can be a determination as to whether a first user has named and/or indicated a specific second user to be a friend. “Similar user profile” can be a degree of matching and/or similarity between elements of a first user's profile and elements of a second user's profile. “Similar user history” can be a degree of matching and/or similarity between elements of a first user's history and elements of a second user's history.

The system can be described as emergent because coherent documents published for viewers can emerge from relatively simple rules applied to the information in the system, and can be formed without substantial explicit organization of the document product by a single person or entity, that is, by an editor. No editor substantially specifically organizes the product document at a high level. That is, no editor is substantially organizing the process by which content is contributed and/or published, or organizing the structure of the resulting document, or selecting specific content elements for publication.

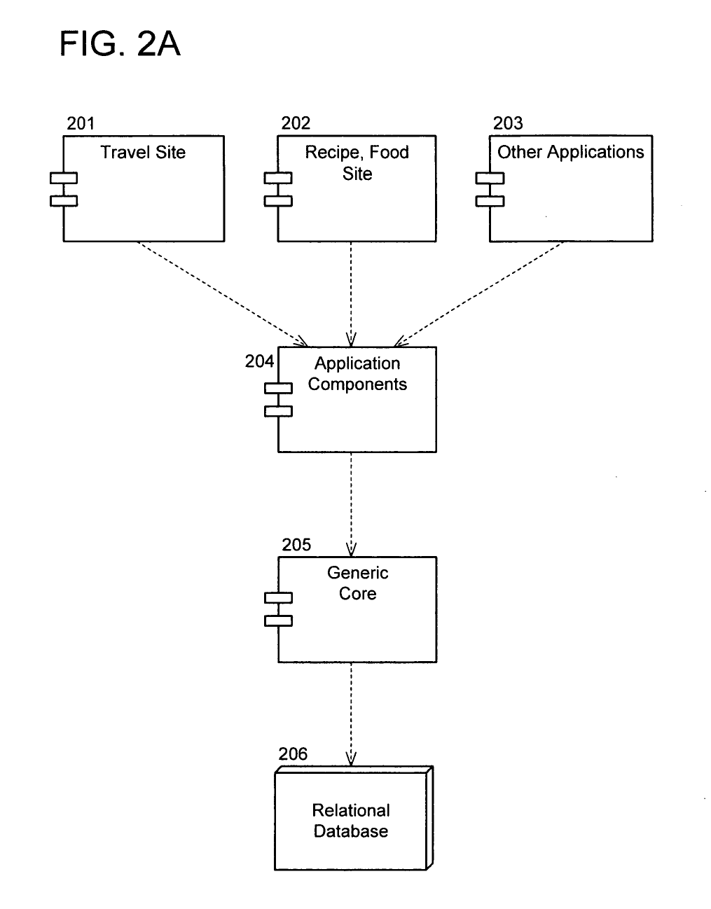

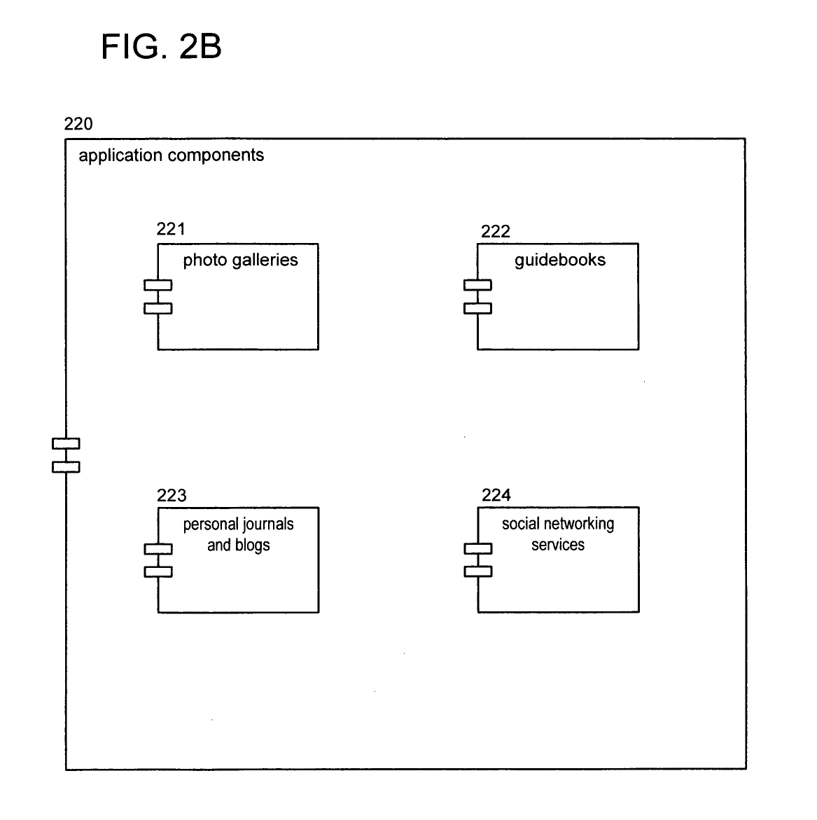

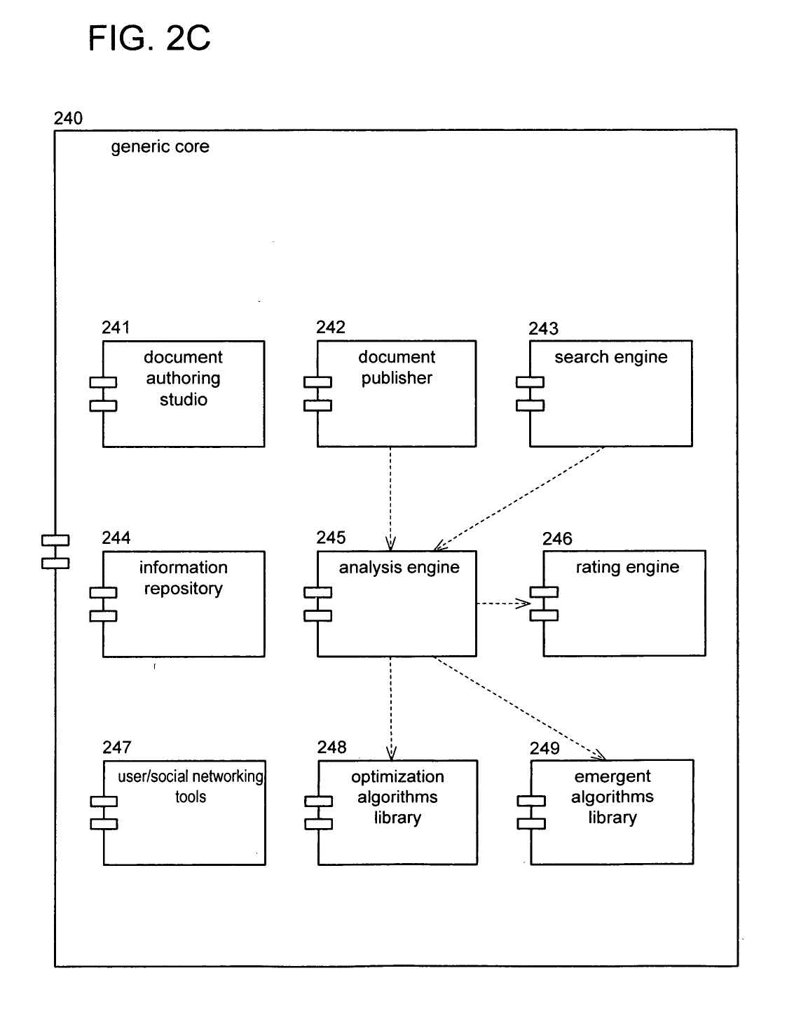

FIG. 2A provides an Unified Modeling Language (UML) component diagram of an embodiment. Several high-level applications, including a Travel Site 201, a Recipe/Food Site 202, and other known and/or convenient applications shown as Other Applications 203 can have functionality dependent upon Application Components 204.

These Application Components 204 are commonly available to the applications. In turn, the Application Components 204 can depend upon capabilities in a Generic Core 205. The Generic Core 205 in some embodiments can interact with a Relational Database 206 which can support storage and organization of information including content elements and other information. In some embodiments the Relational Database 206 can contain one or more storage mechanisms that contain the information of a knowledge repository. In some embodiments, the Relational Database 206 can include abstractions, such as pointers, of the information of a knowledge repository, wherein one or more storage mechanisms' that contain the information of a knowledge repository are remote to the Relational Database 206.

One of the Other Applications 203 that can be supported is that of a Social Networking site. Capabilities for users of a social networking site can include one or more of the following: mutual interactions with other users of the site, rating and reviewing of (other) users, building lists of friends, inviting friends to participate in activities, meeting new friends, building networks of friends, and individual users trusting their friends (or friends of friends, etc.) to a greater degree than unrelated users.

FIG. 2B adds detail to the UML component diagram of the embodiment shown in FIG. 2A. Specific application components that can be within the Applications Component 204 block of FIG. 2A are shown within Applications Component 220. Application components that can comprise this functional block include photo galleries 221, guidebooks 222, personal journals and blogs 223, social networking services 224 and/or any other known and/or convenient application providing a data source. In some embodiments, support for a travel guide function within a Travel site can be provided in guidebooks 222.

FIG. 2C adds detail to the UML component diagram of the embodiment shown in FIG. 2A. Specific processes that can be within the Generic Core 205 block of FIG. 2A are shown within Generic Core 240.

A document authoring environment, document authoring studio 241, can provide tools for contributors to submit content, modify existing content, view history of content revisions, set metadata on content, organize content, and otherwise manage content in the system. In an authoring context, private content refers to content for which permissions to change and/or edit the content is restricted to a single author. In an authoring context, shared content refers to content for which more than one author has permissions to change and/or edit the content. This document authoring environment can be used to modify private content and/or shared content, depending on the application and context.

A document publishing subsystem, document publisher 242, can support organizing and composing content into a coherent fashion, suitable for viewing. The content to be organized and/or composed can be “selected content”, which can mean that a viewer or other user has explicitly designated particular content. The content to be organized and/or composed can also be “derived content”, which can mean that the system has designated particular content as a result of taking into account particular characteristics of a viewer or other user. A document publishing engine can organize material using particular approaches described herein.

Published documents can comprise a composition of two classifications of content: inactive content that is organized by a particular contributor (such as an author) and that can be selected and presented according to viewer preferences and interests, stated and/or derived; and active content, whose selection can be made according to both contributor's (such as an author's) constraints, if any, and viewer's preferences.

Document publisher 242 can be used to support the following system capabilities:
(1) The size of a portion of and/or a complete presentation and/or publication, such as a document, can be responsive to a viewer's verbosity preference. A viewer can configure his or her verbosity preference at one or more hierarchical levels including a global basis pertaining to all presentations and/or publications, and/or an individual basis, pertaining to single instances of presentations and/or publications. Verbosity preference can be represented as one or more parameters within a viewer's preferences that can indicate a viewer's desired absolute and/or relative quantity of output for presentation and/or publications. Verbosity can be parameterized in units of one or more of words, paragraphs, sections, topics, and/or other known and/or convenient groupings of information suitable for a presentation and/or publication.
(2) Content nodes can be selected for presentation and/or publication based on a viewer's preferences for content type. A content node is a convenient grouping of content information, such as a paragraph or a section. Viewers can explicitly select their viewer preferences for content type such as good writing, practical material, witty, and/or humorous content types. Content nodes can be rated as to best matches to a viewer's preferences for content type and/or other criteria. A content node rating can be responsive to averaging user input previously obtained, that is, voting.
(3) Content nodes can be selected based on similar profiles, that is, matching of a viewer's profile and a content author's profile.
(4) Content nodes can be selected based on an author's rating. Viewers and/or other users can provide ratings of authors to the system. The system can combine many users' ratings of authors to produce a personalized rating of an author for a particular viewer. This system behavior can be described as an emergent process and/or emergent algorithm.
(5) The system can dynamically generate content nodes. Dynamically generated content nodes are known as active content nodes. Active content nodes can include a list of content items. Active content nodes can be influenced by a viewer's preferences for activity Types. Active content nodes can be constrained, that is, organized, by an author. An author can organize a context-sensitive query. By way of non-limiting example, within a Travel Guide, within a section on food and drink, an author could organize a special section on Indian food in London based on the author's notion that Indian food is a notable feature of food and drink in London.

A search engine 243 provides services to generate a list of results out of the knowledge content contained in the information repository 244 and using the analysis engine 245. This search engine 243 can complement the document publisher 242 to produce results that can have emergent properties. These results can be organized differently than documents produced by means of document publisher 242. The search engine can produce results that can differ from those of a traditional search engine through the use of an analysis engine 245 that can consider emergent algorithms such as those supported in the emergent algorithms library 249. The search engine 243 can be used to generate recommendations considering viewer preferences. For example, the search engine 243 can be used in a travel application to generate a set of restaurants responsive to a viewer's preferences, stated or derived.

In one embodiment an information repository 244 can provide support for organizing and managing the knowledge content for the system. The information repository can be implemented using a relational database or other data storage system. In some embodiments the information repository 244 can contain one or more storage mechanisms that contain the knowledge content. In some embodiments the information repository 244 can include abstractions, of the knowledge content, such as pointers, wherein one or more storage mechanisms that contain the knowledge content are remote to the information repository 244. Information can be provided using a common content model, which allows for the convenient organization of content, as well as application of metadata.

An analysis engine subsystem, analysis engine 245, can support deriving appropriate content for each viewer (end user), based on each viewer's stated and derived preferences. Content is intended as a broad term, and can comprise any in combination or all of: text, documents, and digital media, such as images, photos, videos, audio, other users, user groups, favorites lists, classification metadata. There can be additional forms of content.

A rating subsystem, rating engine 246, can support the functionality of users providing ratings for items along a number of dimensions. The list of potentially ratable items can comprise one or more of individual content elements (e.g., text paragraphs, photos, images, video, audio), dynamically published content documents, other users, user groups, favorites lists, and classification metadata. There can be additional ratable items.

Social networking services 224 can be supported by user/social networking tools 247. These services and tools provide access to a social networking subsystem, whereby users can share information regarding their interests, their preferences, and their favorite items. This information can be shared with selected groups of people. The groups of people can be stated explicitly by users and/or others. Alternatively the groupings of people can be derived by other means such as grouping by measures of similarity between users. The social networking subsystem can enable users to view, search, and analyze shared resources from other users, who can designate the viewer as having a degree of similarity, or whose similarity can be evaluated using algorithms that can be emergent algorithms. By way of non-limiting example, similarity can be evaluated by performing pattern-matching on user information. A social networking subsystem can enable users to get recommendations and information from their friends and network of friends which they may more readily trust and value.

An optimization algorithms library 248 can comprise a collection of general and specific optimization algorithms which can be used to organize and select content. Optimizing algorithms can provide for a variety of needs, in order to select the most desirable content given various constraints and preferences. These algorithms can differ from emergent algorithms in that they specify optimization in a domain-specific manner. By way of non-limiting example, the optimization algorithms library can contain algorithms that optimize recipes to provide for a specific diet. While the viewer's preferences can influence content selection through algorithms that can be emergent algorithms, the optimization algorithms can control processes that can be emergent processes to respect domain knowledge. By way of the previous non-limiting example, the optimization algorithms can control processes so as to settle on a level of caloric intake within a particular diet.

An emergent algorithms library 249 can comprise a collection of general and specific emergent algorithms which can be used to determine the interests of a user. Using these emergent algorithms, the analysis engine can derive the best results for a particular viewer, such as an end user. Algorithms within the emergent algorithms library 249 can be used to support the following system capabilities:
(1) Community of Interests: To support selection of preferred content items or content documents, the system can determine a community of interests. Content which has been highly rated by other users in the community can take precedence, and content which has been lowly rated by other users in the community can be devalued. A community of interests can be derived by analyzing the similarity between users by taking into account data that can include by way of example and not limitation a set of application-specific user metadata, user history, and stated or implied preferences. Implied preferences can be derived by considering a viewer's rating of this or similar items. For an example travel application, this can include, but not be limited to, location selection, user travel history, and stated or implied travel preferences.
(2) Emergent Content based on Ratings and User-rated Ratings: Derivation of content can be based on weighted selection from source material, where each source can be rated by considering location and venue review ratings and reviewer's ratings.
(3) Emergent Content based on User Similarity: Selection of content from the repository can be based on weighted similarity between a profile of the viewer and a profile of the author, or based on the weighted similarity between a profile of the viewer and a profile of the reviewer. For example, a 20 year old student viewer can first access material written by or reviewed by other 20 year old students.
(4) Emergent Content based on User History: Selection of content from the repository can be based on considering the viewer's history. For example, a user who has traveled to Thailand and Brazil can get trip recommendations based on the preferences of other users whose travel history most closely matches the viewer.
(5) Emergent Content based on Relative Valuation of Relevancy Dimensions: Derivation of content can be based on weighted selection of source material, where each source can be rated by relative valuation by means of a set of relevancy algorithms. Relevancy algorithms can include any or all of, but are not limited to, the following: common match of keywords in source text, prioritization by date, prioritization by Community of Interest, User Similarity, Ratings, and User-rated Ratings.
(6) Dynamic Content Selection and Coherent Document Publishing: Content that is selected using these and other algorithms can be published into a coherent document (that is, a document having document coherency) using algorithms with the following properties (the properties alone or in combination with one another):
(7) Having an agreed on hierarchy, wherein content selection can be made according to organization which can be selected by authors and which can be agreed upon by a community;
a) Topical classifiers—the topic of each content node can be specified, and other metadata can be indicated, such as singular, required, and/or numerous other known and/or convenient metadata. In some embodiments the content is not identified as singular or required, and the system can select the top rated content items in each topic. The quantity of content items selected can be responsive to a limit specified in a user's verbosity preferences. The number of items selected from each topic can be in proportion to each other, and/or can be influenced by a user's preference. For example, a higher selection of historical content; and,
b) Template design—Master templates can be used to organize content data in a top-down fashion, wherein items can be selected which are most suitable for the viewer.
(8) Emergent Documents based on Verbosity Preferences: Content selection can be tuned by taking into account user verbosity preference when the system composes content to form a document using the coherency approaches listed above. This tuning can reduce the (verbosity of) content based on the weighted selection of source material, responsive to a quantity determined by a viewer's verbosity preference level.

The document publisher 242 and search engine 243 subsystems can have dependencies upon the analysis engine 245 subsystem. In turn, the analysis engine 245 subsystem can have dependencies upon the rating engine 246, optimization algorithms library 248, and emergent algorithms library 249 subsystems. The analysis engine 245, rating engine 246, and libraries 248 and 249 can all operate on knowledge content contained in the information repository 244.

The document publisher 242 and the search engine 243 can utilize the analysis engine 245 to generate recommendations. Such recommendation generation can be in response to a user query or performed in an application-specific context. These recommendations can take the form of a simple list, which can be embodied as flat or hierarchical. A selection between flat and hierarchical embodiments can be responsive to related metadata. The recommendation generator can utilize a viewer's stated or derived preferences.

A recommendation generation subsystem within analysis engine 245 can be embodied using a statistical inference model. The statistical inference model can use techniques such as latent semantic mapping or Bayesian inference. These techniques can be used to determine ratings a viewer would be likely to assign were the viewer to rate the content. A model can provide greater confidence on its estimates for which specific preferences have been stated by the viewer. Recommendations can be made when statistical confidence is sufficiently high.

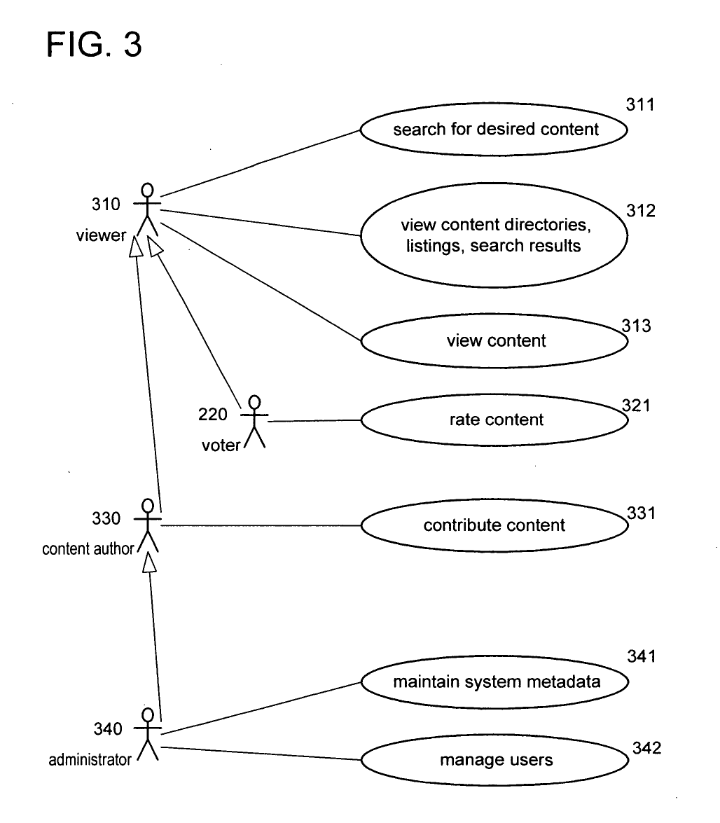

FIG. 3 illustrates roles and non-limiting, exemplary use cases in a UML use case diagram, for an embodiment.

One or more authors, shown as content author 330, can contribute content 331. Typical applications can involve numerous authors, but the system can be utilized by one or few authors. For example, in an embodiment an application can be modeled after a traditional publishing company that has few authors. In some embodiments the content can be static, in which case there is substantially no interaction with content authors.

Content can be utilized by content viewers, shown as viewer 310. There can be few or numerous content viewers. Typical applications can involve numerous viewers, but the system can be limited to one or few viewers, depending on the application. A viewer can search for desired content 311, can view content directories, listings, and search results 312, and can view content 313.

Administrators, shown as administrator 340, can maintain system metadata 341. Metadata can be created, edited, deleted, and otherwise maintained by administrators. These privileged users can typically maintain useful content ratings, properties, and organizational metadata. Administrators can also have the responsibility to manage users 342.

Content can be rated through the actions of one or more content voters, shown as voter 320, who can rate content 321 elements. Content elements can comprise one or more of paragraphs or sections of text, photos, images, videos, and audio information. Voters can also rate published content documents, collections of content documents, users, or groups of users.

Individual viewers or classes of viewers may prioritize rating dimensions differently from other viewers. In publishing a personalized document for a particular viewer, the system can take into account the viewer's preferences regarding relative importance of the rating dimensions for elements of content; these viewer preferences can vary for each individual viewer or class of viewers.

The user roles of viewer 310, voter 320, content author 330, and administrator 340 are not necessarily exclusive; some can extend to others and/or will typically overlap. For example, all authors can be considered to be viewers, and in typical applications, viewers can be voters.

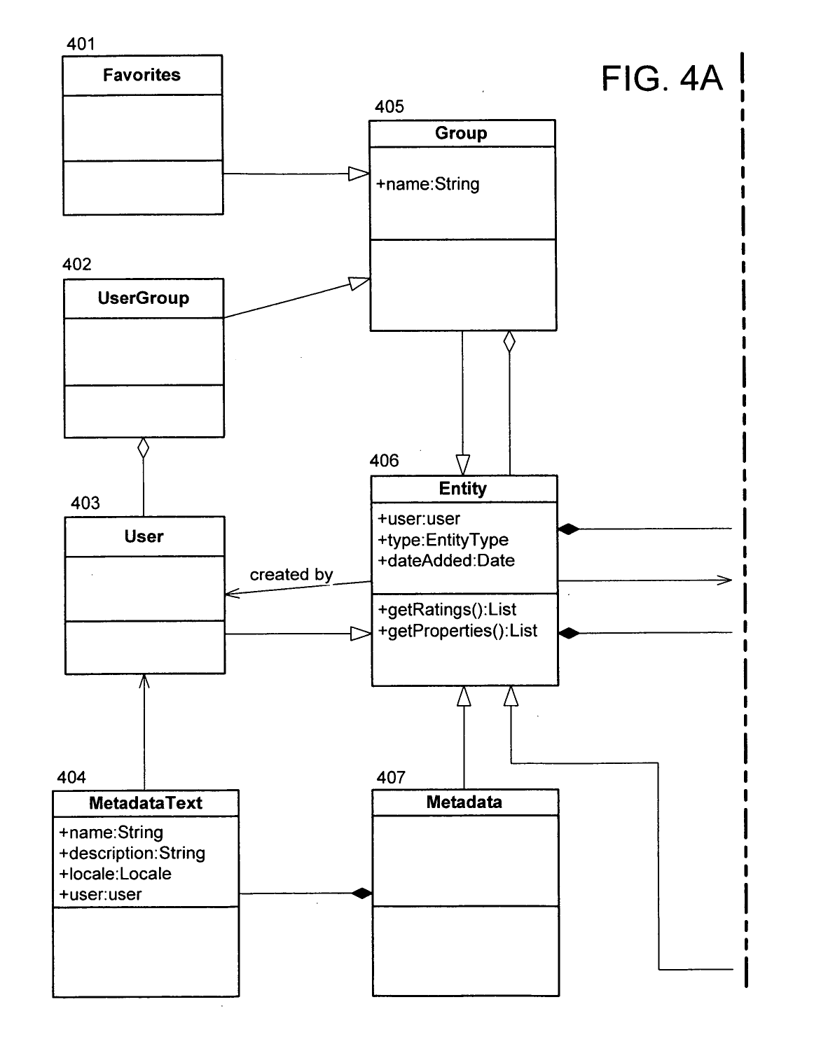

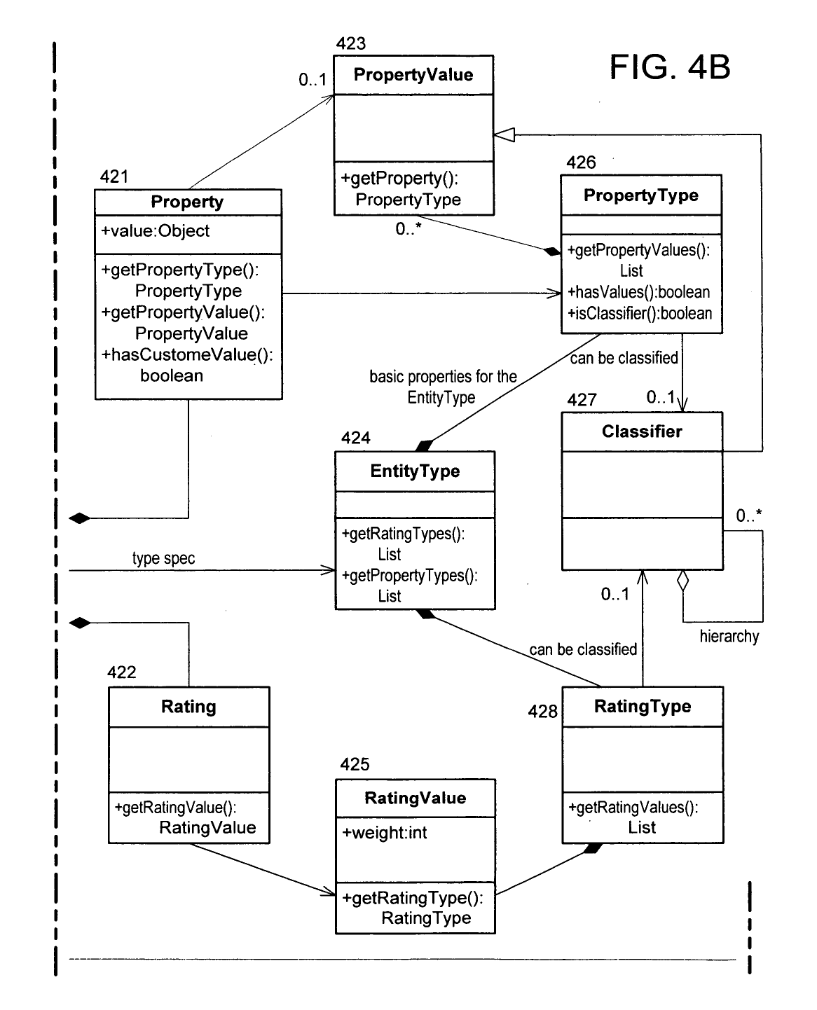

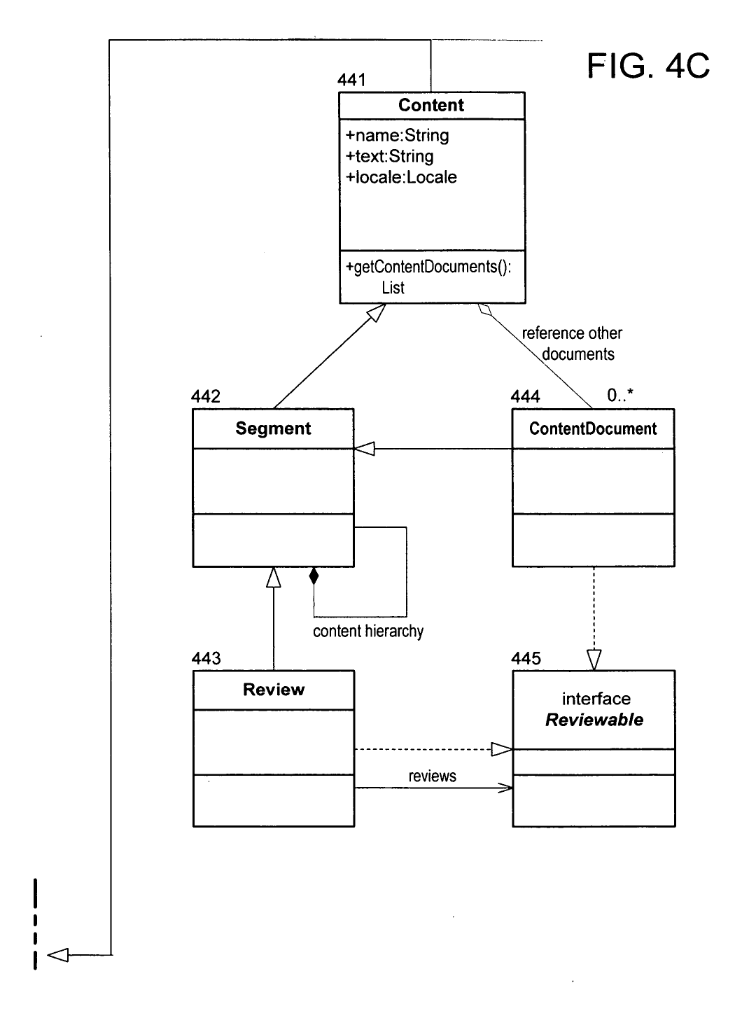

FIGS. 4A, 4B, and 4C illustrate data structures within embodiments of the system. Taken together these figures constitute a UML modeling diagram. In particular, they constitute a class diagram.

An essential class is Entity 406, which can be Metadata 407, a User 403, a Group 405, or Content 441. An Entity is a generic class and can be used to represent high-level items, which can then be rated or assigned properties. An Entity can be created by user ‘user’ on ‘dateAdded’. These corresponding attributes are shown within Entity 406. The type of data that the Entity 406 represents can be identified by the ‘type’ attribute that can indicate an EntityType 424 class.

EntityType 424 can identify the type of an associated Entity 406 as one or more of standard types (Content, Media, Review, ContentDocument) and/or custom types that extend the standard types. Some examples of custom types are Location, LocationGuide, Activity, and Trip.

Content 441 is a subtype of Entity 406. Content 441 can represent a unit of knowledge content for an application. A unit of knowledge content for an application can be a photo, a paragraph of text, a Document, or one of any additional known and/or convenient forms of information. Each Content object has attributes ‘name’ and ‘text’, and can also have a ‘locale’ attribute. A Content object can also reference or link to one or more instances of a ContentDocument 444.

A Segment 442 is a subtype of Content 441. A Segment can be organized hierarchically. A tree of Content can represent a discussion forum or a document.

ContentDocument 444 can be a subtype of Segment 442. A ContentDocument 444 can be a top-level document in the system. A ContentDocument 444 can be composed of a hierarchy of content Segment instances. A ContentDocument 444 can be Reviewable 445, so that a Review 443 can reference it.

Review 443 can be a subtype of Segment 442, which can be a hierarchy of content Segment 442 instances. Review 443 can point to a Reviewable 445 class. A Review 443 can itself be Reviewable 445. This structure can be used to model a discussion forum.

Metadata 407 can be a subtype of Entity 406. Metadata 407 can be used to classify and/or describe other Entity objects. Other Entity objects are often Content 441 but can also be User 403 instances, Group 405 instances, and/or other Metadata. Metadata 407 can be a Property 421 or a Rating 422. Metadata 407 can be supported by MetadataText 404.

MetadataText 407 can provide locale-specific values for Metadata. Each MetadataText 407 object has attributes ‘name’ and ‘description’, and can also have attributes of ‘user’ and/or ‘locale’.

PropertyType 426 is a subtype of Metadata 407. PropertyType 426 can provide flexible properties for describing Content 441, User 403 instances, Group 405 instances, and/or other Metadata. PropertyType 426 can contain a fixed set of values that are defined as PropertyValues. PropertyType 426 can also be free-form, and simply store a ‘value’. One example of a fixed set of values is that PropertyType can represent ‘gender’, and it can have PropertyValues for ‘male’ and ‘female’. One example of a free-form value is that PropertyType can represent ‘age’, and can have a free-form value.

Property is used to assign a property to an Entity, and it includes a PropertyType and either a PropertyValue or a free form ‘value’. A Property also includes the reviewer who contributed the property to the entity.

Property 421 is used to assign a property to an Entity 406. Property 421 includes a PropertyType 426 and either a PropertyValue 423 or a free form ‘value’. A Property 421 can also include a reviewer who contributed a property to an Entity 406.

RatingType 428 is a subtype of Metadata 407, and can provide a flexible rating system to describe Content 441, User 403 instances, Group 405 instances, or other Metadata. RatingType 428 can refer to a rating scale. RatingType 428 can include a set of RatingValue 425 instances. Each RatingValue 425 instance can have an associated numeric value. That numeric value can later be used to generate average ratings on an Entity 406. For example, a RatingType 425 can represent ‘great place to visit’, and include RatingValue 425 instances such as ‘recommended’ and ‘not recommended’. To apply a rating to an Entity 406, the Rating 422 class can be used. The Rating 422 class can refer to a RatingValue 425. The Rating 422 class can also refer to a specific reviewer who contributed a specific rating.

Classifier 427 is a subtype of PropertyValue 423. Classifier 427 can be used to classify Entity 406 instances. Classifier 427 can have a parent Classifier; therefore Classifier 427 can represent a tree of PropertyValue 423 instances. For example, PropertyType 426 attribute value ‘location’ can be a Classifier instance, and its Classifier attribute values can include regions, countries, and/or cities. A Classifier instance can refer to its parent Classifier thereby forming a hierarchy.

PropertyType 426 instances and RatingType 428 instances can also be classified by means of a Classifier, such that they only apply to Entity 406 instances that are defined with the Classifier. For example, an application may have an ‘Activity’ Entity that can be defined as a ‘Restaurant’. Only ‘Restaurant’ would have a rating ‘food quality’, so the RatingType would be classified by an ‘ActivityType’ PropertyType Classifier.

The system can represent users with User 403, an Entity 406 subtype. User 403 instances can have standard user properties.

Group 405 can be used to create groups of objects. Group 405 is a subtype of Entity 406. Group 405 can refer to other Entity 406 instances. Subtypes of Group 405 can include UserGroup 402 and/or Favorites 401. These subtypes can be used to create a group of User 403 instances or a custom set of other Entity 406 instances, respectively. In an application, these can be used to build a list of friends or a list of favorites (such as locations), respectively.

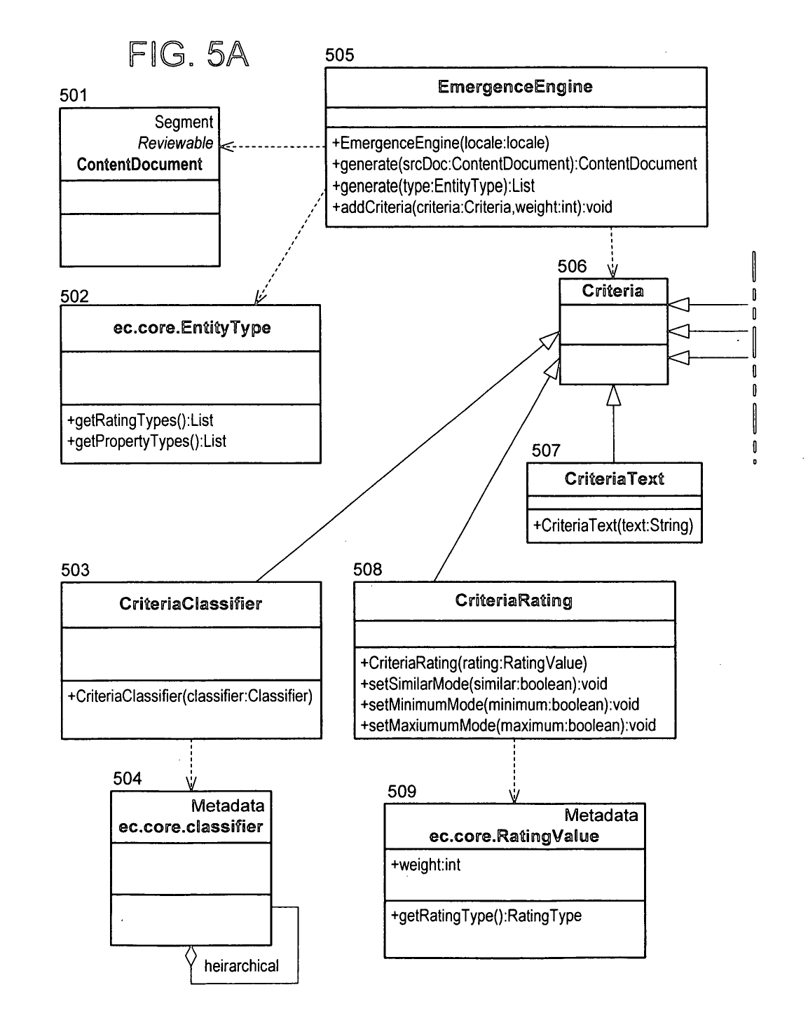

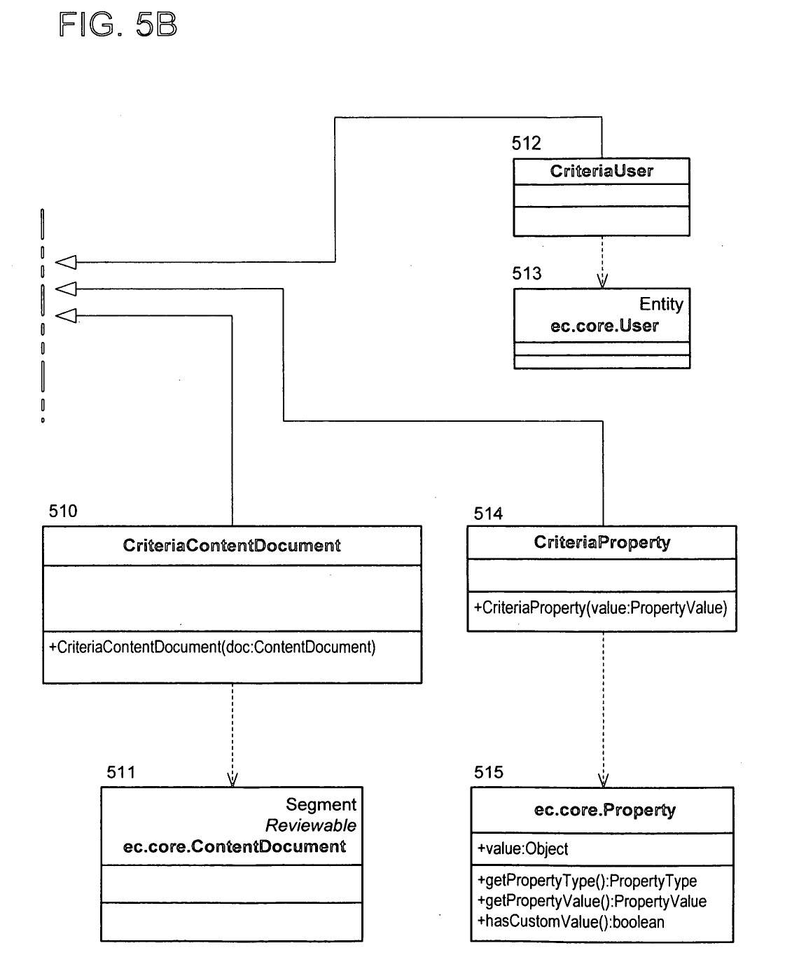

The combination of FIG. 5A and FIG. 5B illustrate the specification of a high-level interface for a generic EmergenceEngine API (application programming interface). EmergenceEngine 505 can provide services such as specifying personalization criteria, and then generating a document or generating a list of items. The services provided can be described as emergent services. The documents generated can be described as emergent documents. The items listed can be described as emergent items.

When an emergent document is generated, the document ContentDocument 501 can be specified as in FIG. 4C, as a hierarchy of content nodes Content 441. When a list of emergent items is generated, each item can be of optional EntityType, that is, ec.core.EntityType 502.

In order to guide a personalization process, one or more criteria Criteria 506 can be specified. These criteria can specify search text CriteriaText 507, specific ratings from a multi-dimensional set of rating scales CriteriaRating 508, content metadata CriteriaClassifier 503 or CriteriaProperty 514, authors or authorized viewers CriteriaUser 512, or other documents CriteriaContentDocument 510. When ratings are specified using CriteriaRating 508, they can be indicated through a specific RatingValue, ec.core.RatingValue 509. Likewise, if classifiers are specified as criteria, they can be indicated through classifier values, ec.core.classifier 504. When properties CriteriaProperty 514 are used, they can be indicated through particular properties, ec.core.Property 515. When other document instances CriteriaContentDocument 510 are used, they can be indicated by a specific document ec.core.ContentDocument 511.

When an emergent or other process relies on user preferences using CriteriaUser 512, then the process can refer to a particular user, User, shown as ec.coreUser 513, which can be identical to a content user embodied in User 403. The user of 513 or 403 can refer to an actor in the system. The actor may have contributed content, rated content, viewed content, or simply been referenced through a friend's group such as UserGroup 402.

In a system embodiment with multiple contributing authors, content can be published which was contributed from numerous sources. Authors can be paid based on their proportional contributions to the content of the output document. This can be generalized to a technique of paying contributors based on their proportional contribution of output content, which may include photos, videos, music, and other digital media.

For example, if 5% of a document published by the system consists of content from user A, user A can be paid 5% of the income distributed to authors as a result of that document. Income may result from ad revenue, paid subscriptions, purchased documents, and any other known and/or convenient source. Similarly, if a published product of the system is a slideshow that includes user B's contributed photographs, user B can be paid proportionally to the relative frequency with which user B's contributed photographs are exhibited.

In some embodiments, this can be further generalized to a multi-author environment, where each contributor's work is published as separate work. For example, a system that hosts blogs can generate income. Individual contributors can each be paid in proportion to the revenue generated through ads presented in association with the individual contributors' blogs. Ads can be simply presented alongside each individual blog.

A system can publish a single document comprising content authored or otherwise contributed by multiple users. A system can use one or more known or convenient algorithms to calculate and assign proportional income shares for the contributing users (authors), taking into account differences between revisions of the document. Whether a revised document or a slideshow of images is published, the contributing users will be paid in proportion to their shares.

In one example embodiment, a document is first authored by UserA, and later revised by UserB. The system can calculate and update the different income shares between versions. If UserB's contribution constitutes 20% of the revised document, UserA can be assigned 80% of the income shares associated with the revised document, and UserB assigned 20% of the associated income shares. When a UserC further revises the document at 20%, UserC can be assigned income shares of 20%, and UserA and UserB can have their respective income shares scaled down proportionally (to 64% and 16%, respectively, in this example).

In measuring the difference between revisions, various algorithms can be used. One such algorithm can consider the amount of text added, deleted, or changed. Additions can carry a heavier weight than deletions or changes. For example, when UserA first writes 4000 words, and UserB adds 2000 new words, UserA can be assigned 66% and UserB assigned 33% of resulting income shares for the document resulting from the combined efforts. However, when UserB adds 2000 words but also deletes 2000 of UserA's first written 4000 words, UserA can be assigned 60% and UserB assigned 40%. Such an algorithm can be expressed as follows:
SHARE=(Wadded+(0.2* Wdeleted)+(0.4* Wchanged))/Wcount,
wherein
SHARE=income shares allocated to a contributor for contributing to a revised document,
Wadded=the number of words added to the revised document by a contributor,
Wdeleted=the number of words deleted by a contributor,
Wchanged=the number of words changed by a contributor,
Wcount=the number of words remaining in a revised document.

This is a one example of an algorithm within an embodiment. Other suitable known and/or convenient algorithms can consider spelling/grammar corrections, rewording, reordering, and other variations.

The core system can be used by many applications such as those listed here by way of example and not limitation:
Travel, including Travel Sites—authors can contribute their knowledge and digital media resources to Travel Guides and/or to personal Travel Journals. Content elements and other information can be rated and classified using flexible metadata. Viewers can utilize the system to produce a personalized Travel Guide, which can match their particular interests, preferences, histories, and/or itineraries. The viewers' interests, preferences, and other characteristics and properties can be stated or derived by the system. This application can correspond to Travel Site 201.
Food, Recipe, Cooking, Diet, including Food Sites—authors can contribute recipes, nutritional information, and/or cooking tips, which are rated and classified using flexible metadata. Viewers can utilize the system to produce a personalized recipe books and/or meal plans. The recipe books and/or meal plans can take into account viewer interests, preferences, history, diet, habits, and/or food availability. The viewers' interests, preferences, and other characteristics can be stated or derived by the system. This application can correspond to Recipe/Food Site 202.
Consumer Product Reviews—authors can contribute their knowledge of products. The products can be rated and classified using flexible metadata. Viewers can utilize the system to get personalize product recommendations. These product-recommendations can take into account viewer interests, preferences, history, and/or budget constraints. This application can correspond to Other Applications 203.
Museum—authors can contribute their knowledge and digital media resources to construct online galleries of historical, cultural, social artistic, scientific, or other types. Viewers can utilize the system to browse and explore personalized selection of galleries (e.g., take a personalized tour). The personalized galleries can take into account viewers' interests, preferences, history, and other characteristics and properties. This application can correspond to Other Applications 203.
Entertainment Reviews—These reviews can address movies, video games, music, events, and other known and/or convenient forms of entertainment. Authors can contribute their knowledge and digital media resources to the system in order to create an online collection of reviews of entertainment, such as movies, video games, and music. Viewers can utilize the system to browse and explore personalized selection of events and products. These personalized selections can take into account viewers' interests, preferences, history, and other characteristics and properties. This application can correspond to Other Applications 203.
Book Reviews—authors can contribute their knowledge and digital media resources to construct online collections of book reviews. Viewers can utilize the system to browse and explore a personalized selection of books. These personalized selections can take into account viewers' interests, preferences, history, and other characteristics and properties. This application can correspond to Other Applications 203.
Guidebooks for Art, Architecture, Apartments, Flowers, Furniture, Fashion, etc.—Authors can contribute their knowledge and digital media resources to construct online galleries of art, architecture, apartments, flowers, furniture, and fashion, or other types. Viewers can utilize the system to browse and explore personalized selections of objects. These personalize selections can take into account viewers' interests, preferences, history, and other characteristics and properties. This application can correspond to Other Applications 203.

The core system framework herein described, is capable of supporting one or more knowledge-based applications, and other application types such as Social Networking. These applications can include a Travel site, a Food site, and others. The existence of a single core system framework to support multiple applications and/or sites can provide efficiencies in design and maintenance of the system. Common designs and common functions can be supported, thereby avoiding a need to separately design and separately maintain the core functionality of the individual applications and/or sites.

An application embodiment, VCarious Travel Share, is herein described.

VCarious is based on the concept of a personalized travel guide, which is similar to a printed Travel Guide or other online Travel Guide, but can be customized for each user. In addition to Travel Guides, VCarious can support personal Travel Journals, which are shared and can be published in a personalized fashion. Activity listings (restaurants, hotels, and/or numerous other known and/or convenient activities) and digital media can be separated, and can be used independently or as components of a Guide or Journal.

The system can publish personalized Travel Guides (and other travel resources) in an automatic fashion, responsive to preferences that can be specified by the viewer and/or preferences that can be automatically derived from the viewer's profile, history, ratings, and other aspects.

VCarious is an application for the Generic Core System. VCarious is designed to handle three main types of travel data: Travel Guides, which can be an online form of the popular Travel Guides found in print; Travel Journals, which can be personal experiences contributed by users; and an Activity Guide, which can be a brief summary or detailed guide to any common location-based activity or business, such as restaurants, hotels, bars, clubs, museums, monuments, shopping, sports, etc

These three types can extend the ContentDocument 444 concept introduced in the core system. In addition to these three main types, VCarious can support other types through extension of the generic core: Digital Media, which can be a repository of digital images, photos, video, audio, etc; Users which can be entities in the core system, which have properties, ratings, and which may have social networking capabilities; and, Groups is an organizational tool for the end-user for collecting selected users for access control or invitation purposes, as well as a tool for collecting favorites and lists of items of interest

All six types summarized above can extend core entities and can integrate with core services. These entities can have flexible sets of properties, which can be used for classification by the author. They can also have multi-dimensional ratings, that is, any entity can be rated in substantially unlimited ways, with a set of ratings specific to that entity type.

The top three items (Travel Guides, Travel Journals, and Activity Guides) can be authored content documents. That is, the structure of each can be explicitly chosen by authors.

Travel Journals, Digital Media, and Groups can be written by one author, or can be written by delegated associates, and can be strictly protected according to author preferences. Travel Guides and Activity Guides can be authored by one or more users that endeavor to organize the document in a coherent fashion.

Some other application specific entities can be summarized as: Location—Classifier metadata, which can be a hierarchy of logical locations, which hierarchy level can be specified by LocationType, which can indicate CONTINENT, REGION, COUNTRY, STATE, CITY, AREA; and, ActivityType—Classifier metadata, which can be a hierarchy of logical types, which can include items such as Restaurants, Hotels, Shopping, Nightlife, Museums, and/or numerous other known and/or convenient logical types.

Some other relationships between these items can be summarized as: Content Documents can include content references to Activities, Locations, and Digital Media; Digital Media can be organized by Location, access control restrictions, and media-specific properties; Travel Journals can be organized by User and by Location; Travel Guides can be organized by Location; and, Activity Guides can be organized by Location and Activity Type

In VCarious a document can be formed from a tree of content. Each content node can be a paragraph of text, or can be several related paragraphs of text, and can depend on the author writing style. Digital Media can be considered to be a content node. The organization of a content tree can be explicitly chosen by the author. Each level of the content tree can typically represent descending style.

When authoring a document, a user can create Active Content, which can be a dynamic extension of normal content. For Active Content, the author can define rules, whereby the system can automatically assemble child content at runtime based on a viewer's preferences.

Personalized publishing can be an automatic process executed by system software. Personalized publishing can include, but is not limited to, the following aspects:
Selecting restaurants, accommodations, bars, and other activity items based on a viewer's stated preferences. For example, a businessman may select Quality or Luxury hotels, high-quality food in the categories of French and Italian, British pubs, and particular museums. A student traveler may select Economy hotels, good value restaurants, popular clubs, and/or numerous other known and/or convenient classifications.
Selecting specific locations to match a specific itinerary.
Selecting photos, videos, and other digital media to match a user's selected interests (locations in itinerary and activity listings, as indicated above) and/or to match a user's implied interests (see algorithms below)
Selection of travel journals to match a user's interests.
Publishing of prepared document text in such a way as to match a user's interests.

During this automatic publishing process, the system can produce lists of items or coherent documents that can be formed from the items which match a viewer's interests.

A viewer's interests can be determined using a library of algorithms which can have emergent properties, that is, emergent algorithms, which may be generic or application-specific. These are covered in detail below.

An application embodiment, Food/Recipes/Diet, is herein described.

This embodiment provides a system for sharing a plurality of types of information on food, recipes, cooking, diet, and nutrition. It can be used to generate personalized recipe guides, which can match the user's stated and implied preferences, by means of using emergent algorithms. It can also be used for other purposes, such as planning a diet for purposes related to health, diet, and/or nutrition, which incorporate practical, as well as social, cultural, or personal preferences.

This can be an application of the core framework, extended with specialized algorithms that consider domain knowledge to optimize emergence, that is, emergent properties. The system can also be integrated with various third-party services to further optimize the emergent properties.

The system can utilize useful metadata, such as various dietary classifications. For example, a few classifications can include:
Personal: vegetarian, vegan, omnivore
Medical: diabetic, allergies
Dietary: Atkins, Fat-free, Low Calorie
Cultural: Hindi/Delhi, Thai/Northern, Chinese/Cantonese, USA/Southern American
Seasonal: summer, winter
Style: hot, cold

Recipes can be rated along a number of dimensions, providing a rich set of data on both the recipes value and the user's preferences. Ratings can include but are not limited to taste, texture, difficulty level, and spiciness.

Recipes can be selected to match a user's preferences, stated or implied, through emergent algorithms specified earlier, responsive to a rich set of metadata and ratings. Recipe selection criteria can include metadata such as food style and dietary preferences, user ratings of the recipes, recommendations from friends, preferences of similar users, and/or numerous other known and/or convenient data.

Selected recipes can be compiled into a coherent document, such as a generic cookbook which can nonetheless be personalized to meet users' preferences. Recipes can also be compiled into a meal plan on various time scales, which can take into account short-term factors.

Recipes can be selected and published as a personalized meal plan, which can take into account metadata, and can also utilize context-specific algorithms. Publication of personalized meal plans can be responsive to metadata and/or context-specific algorithms. The meal plans can, as a result, have one or more of the following and/or other attributes: time-range convenient to the user; optimization for variety of food along numerous dimensions (avoiding repeats, encouraging multi-cultural meals, etc); selection by seasonal factors of the ingredients; optimize meals to use similar ingredients, avoiding the time spent shopping; optimize meals to be cost effective; optimize meals to support various dietary preferences (some examples are: minimize caloric intake and fat intake; maximize organic produce); and, select meals where all ingredients can be found in a certain store, which can be known through integration with inventory databases, avoiding the inefficiencies of using multiple shopping centers

When short-term meal plans are constructed, they can be published as shopping lists. The meal plans can indicate the ingredients, which can be quantified and summarized as a shopping list.

With appropriate integration to shopping services, the meal plan can also be used to manually or automatically generate food delivery orders.

Through social networking, users can have numerous benefits, which can include: users can share their favorite recipes with their friends; users can discover other users who have contributed favorite recipes; and, users can select recipes through a friends trust network, where recipe valuation can be prioritized by proximity of users.

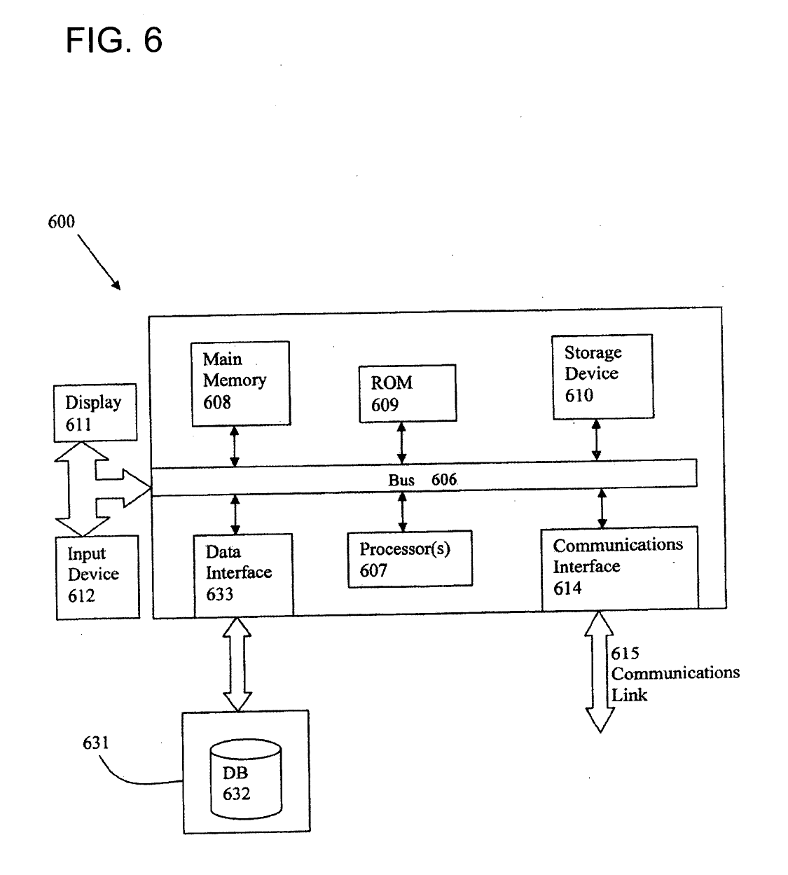

A computer system 600 according to an embodiment will now be described with reference to FIG. 6, which is a block diagram of the functional components of a computer system 600. As used herein, the term computer system 600 is broadly used to describe any computing device that can store and independently run one or more programs.

Each computer system 600 may include a communication interface 614 coupled to the bus 606. The communication interface 614 provides two-way communication between computer systems 600. The communication interface 614 of a respective computer system 600 transmits and receives electrical, electromagnetic or optical signals that include data streams representing various types of signal information, e.g., instructions, messages and data. A communication link 615 links one computer system 600 with another computer system 600. For example, the communication link 615 may be a LAN, in which case the communication interface 614 may be a LAN card, or the communication link 615 may be a PSTN, in which case the communication interface 614 may be an integrated services digital network (ISDN) card or a modem, or the communication link 615 may be the Internet, in which case the communication interface 614 may be a dial-up, cable or wireless modem.

A computer system 600 may transmit and receive messages, data, and instructions, including program, i.e., application, code, through its respective communication link 615 and communication interface 614. Received program code may be executed by the respective processor(s) 607 as it is received, and/or stored in the storage device 610, or other associated non-volatile media, for later execution.

In an embodiment, the computer system 600 operates in conjunction with a data storage system 631, e.g., a data storage system 631 that contains a database 632 that is readily accessible by the computer system 600. The computer system 600 communicates with the data storage system 631 through a data interface 633. A data interface 633, which is coupled to the bus 606, transmits and receives electrical, electromagnetic or optical signals that include data streams representing various types of signal information, e.g., instructions, messages and data. In embodiments, the functions of the data interface 633 may be performed by the communication interface 614.

Computer system 600 includes a bus 606 or other communication mechanism for communicating instructions, messages and data, collectively, information, and one or more processors 607 coupled with the bus 606 for processing information. Computer system 600 also includes a main memory 608, such as a random access memory (RAM) or other dynamic storage device, coupled to the bus 606 for storing dynamic data and instructions to be executed by the processor(s) 607. The main memory 608 also may be used for storing temporary data, i.e., variables, or other intermediate information during execution of instructions by the processor(s) 607.

The computer system 600 may further include a read only memory (ROM) 609 or other static storage device coupled to the bus 606 for storing static data and instructions for the processor(s) 607. A storage device 610, such as a magnetic disk or optical disk, may also be provided and coupled to the bus 606 for storing data and instructions for the processor(s) 607.

A computer system 600 may be coupled via the bus 606 to a display device 611, such as, but not limited to, a cathode ray tube (CRT), for displaying information to a user. An input device 612, e.g., alphanumeric and other keys, is coupled to the bus 606 for communicating information and command selections to the processor(s) 607.

According to one embodiment, an individual computer system 600 performs specific operations by its respective processor(s) 607 executing one or more sequences of one or more instructions contained in the main memory 608. Such instructions may be read into the main memory 608 from another computer-usable medium, such as the ROM 609 or the storage device 610. Execution of the sequences of instructions contained in the main memory 608 causes the processor(s) 607 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 607. Such a medium may take many forms, including, but not limited to, non-volatile, volatile and transmission media. Non-volatile media, i.e., media that can retain information in the absence of power, includes the ROM 609, CD ROM, magnetic tape, and magnetic discs. Volatile media, i.e., media that can not retain information in the absence of power, includes the main memory 608. Transmission media includes coaxial cables, copper wire and fiber optics, including the wires that comprise the bus 606. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

What is claimed is:

1. A method of managing repositories of information, comprising the steps of:
providing content elements;
providing one or more instances of one or more metadata classes;
providing viewer preferences of a viewer;
prioritizing the content elements responsive to analysis of the content elements, the instances of metadata classes, and the viewer preferences.

2. The method of claim 1, further comprising the step of:
selecting content elements responsive to their prioritization.

3. The method of claim 2, further comprising the step of:
publishing a first document comprising the selected content elements.

4. The method of claim 3, further comprising the step of:
generating one or more travel guides.

5. The method of claim 3, further comprising the step of:
generating one or more recipe collections.

6. The method of claim 3, further comprising the step of:
generating one or more meal plans

7. The method of claim 1, wherein content elements are provided by a plurality of contributors.

8. The method of claim 7, further comprising the step of:
selecting content elements responsive to their prioritization.

9. The method of claim 8, further comprising the step of:
publishing a first document comprising the selected content elements.

10. The method of claim 9, further comprising the steps of:
measuring distinct contributors' proportional contributions to a published first document;
partitioning a revenue stream resulting from a published first document into a plurality of portions, each portion corresponding to a distinct contributor, and
wherein the size of each portion is responsive to a measured proportional contribution of a corresponding distinct contributor.

11. The method of claim 9, further comprising the step of:
generating one or more travel guides.

12. The method of claim 9, further comprising the step of:
generating one or more recipe collections.

13. The method of claim 9, further comprising the step of:
generating one or more meal plans.
